(19) United States
(12) Patent Application Publication
(10) Pub. No.: US 2011/0166777 A1
(43) Pub. Date: Jul. 7, 2011

(54) Navigation Application

(76) Inventor: Anand Kumar Chavakula, College Park, MD (US)

(21) Appl. No.: 12/987,068

(22) Filed: Jan. 7, 2011

Related U.S. Application Data
(60) Provisional application No. 61/282,249, filed on Jan. 7, 2010.

(51) Int. Cl. G01C 21/36; G06F 3/048

(52) U.S. Cl. 701/201; 715/771

(57) ABSTRACT

In the field of electronic mapping and GPS related or location based navigation software applications for mobile devices, many applications and features exist to aid a user in knowing current or future conditions of travel like traffic status, current speed, direction, time and distance remaining to reach a certain destination, weather conditions in a certain specified area, points of interest along a specified route and so on to name a few. All of these features can fall into the category of what can be called as Travel Informatics. The current Navigation application features some unique and hitherto unavailable features displayed directly on a digital map and automatically updated to show many useful travel related types of information in an easy to understand user interface that can better aid a user in knowing travel conditions in the context of real-time GPS aided navigation and or desktop finger navigation of digital maps and in other ways as illustrated here.

### REFERENCE TO RELATED APPLICATIONS

This patent application claims the benefit of U.S. Provisional Application No. 61/282,249 filed on Jan. 7, 2009, the disclosure of which is incorporated herein by reference in its entirety.

### BACKGROUND OF THE INVENTION

1. Field of the Invention

The present invention relates to a mobile navigation device having a navigation application icon which, when activated includes features which are used to aid a user in knowing current or future conditions of travel like traffic status, time and distance remaining to reach a certain destination, weather conditions in a certain specified area, points of interest along a specified route, etc. The navigation application features some unique and hitherto unavailable features displayed directly on a digital map and automatically updated to show many useful travel related types of information in an easy to understand user interface that can better aid a user in knowing travel conditions in the context of real-time GPS aided navigation and/or desktop finger navigation of digital maps or on a Television type device or platform.

2. Description of Related Art

In the field of electronic mapping and GPS related or location based navigation software applications for mobile devices, many applications and features exist to aid a user in knowing current or future conditions of travel like traffic status, current speed, direction, time and distance remaining to reach a certain destination, weather conditions in a certain specified area and so on to name a few. All of these features can fall into the category of what can be called as Travel Informatics. The current navigation application includes some unique and hitherto unavailable features displayed directly on a digital map and automatically updated to show many useful travel related types of information in an easy to understand user interface that can better aid a user in knowing travel conditions in the context of real-time GPS aided navigation and/or desktop finger navigation of digital maps. or on a Television type device or platform.

### SUMMARY OF THE INVENTION

In an exemplary embodiment of the present invention, there is disclosed a mobile navigation device for route guidance combined with information related to the route guidance and with a digital map display which is updated to show travel related types of information in an easy to understand user interface that better aids a user in knowing travel conditions in the context of real time GPS aided navigation or desk top finger navigation of digital maps wherein the navigation device comprises a navigation application icon which when activated includes a weather indicator icon which, upon activation displays the weather with corresponding symbol icons that describes in picture form the current weather based on current user location automatically updated, or any location that is specified by a user in a search bar located outside the digital map display.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention.

Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a view of the front of the mobile device showing the various current or future navigation features displayed to an individual in accordance with the principles of the invention;

FIG. 2 is a view of the sunrise and sunset info area;

FIG. 3 is a view of other applications that may be currently installed on the mobile device without the need to leave the navigation application;

FIG. 4 is a view of the Swipe dock bar;

FIG. 5 is a view of video call mapping;

FIG. 6 is a view of navigation application;

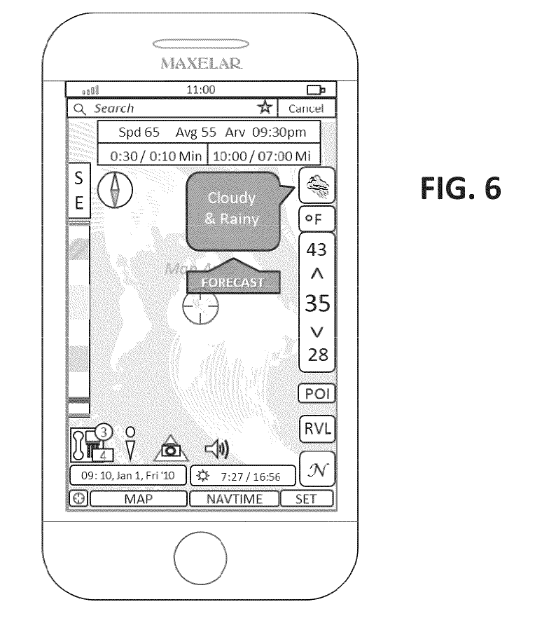

FIG. 7 is a view of temp display change;

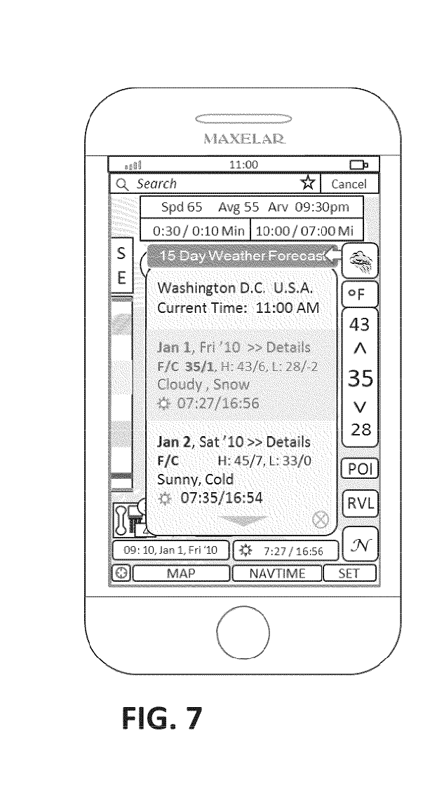

FIG. 8 is a view of dual temp mode;

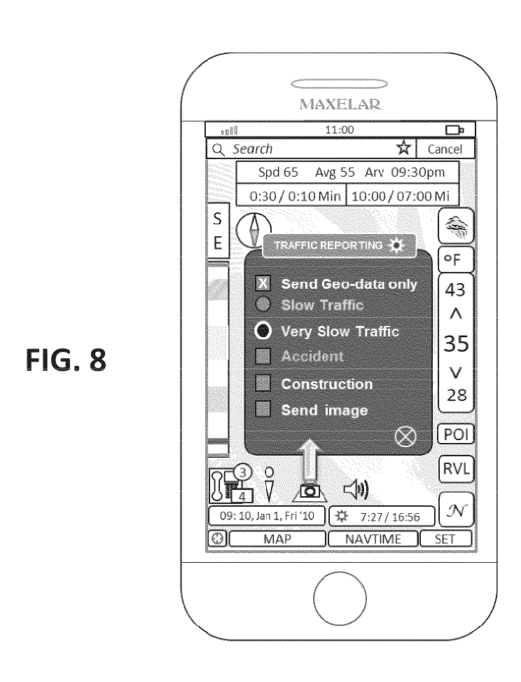

FIG. 9 is a view of Celsius mode;

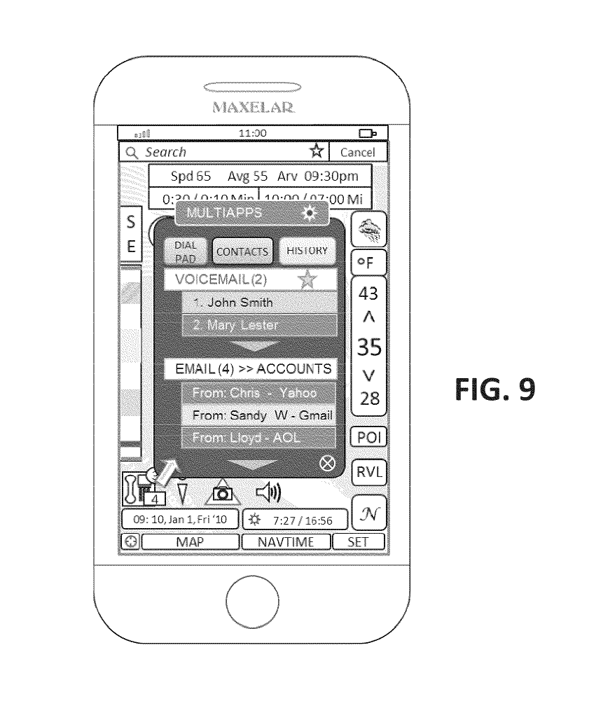

FIG. 10 is a view of weather icon forecast;

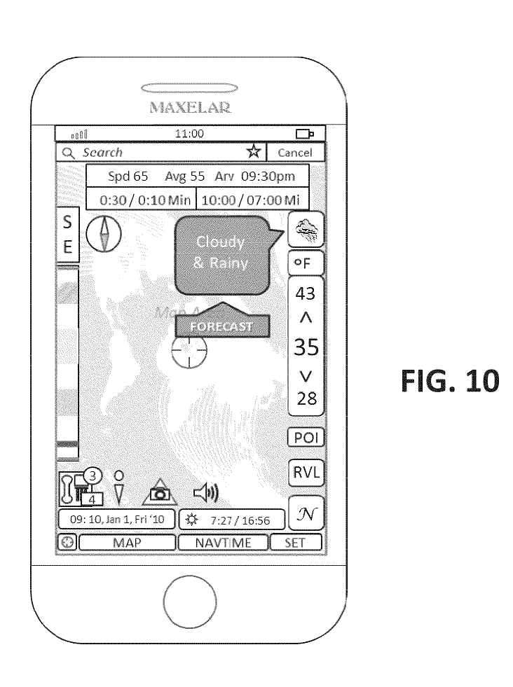

FIG. 11 is a view of forecast display;

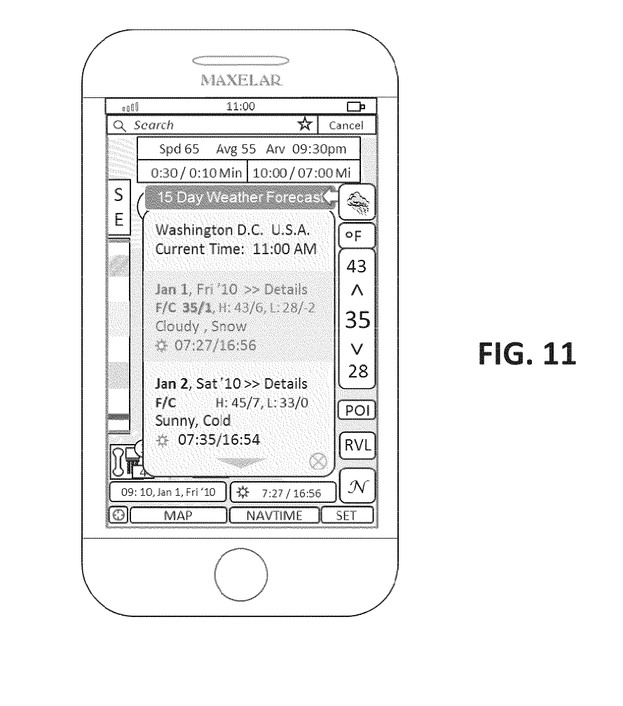

FIG. 12 is a view of traffic report;

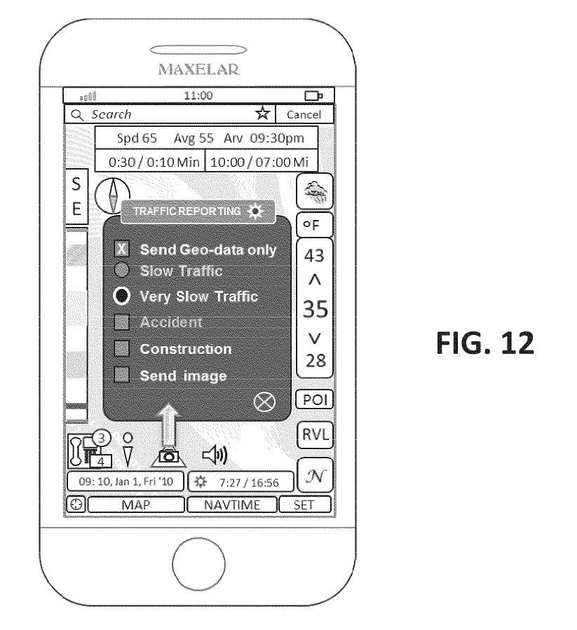

FIG. 13 is a view of combo-corn;

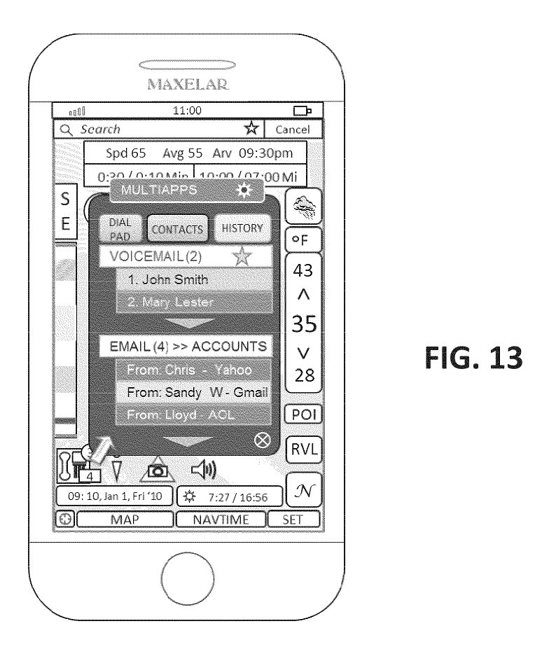

FIG. 14 is a view of swipe doc;

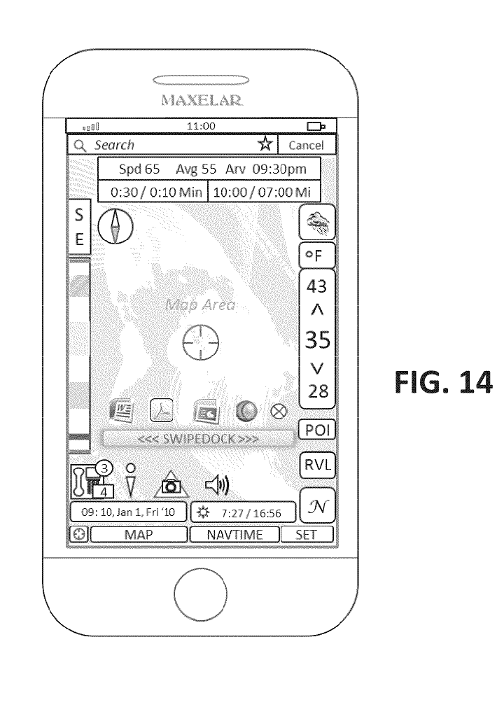

FIG. 15 is a view of app close;

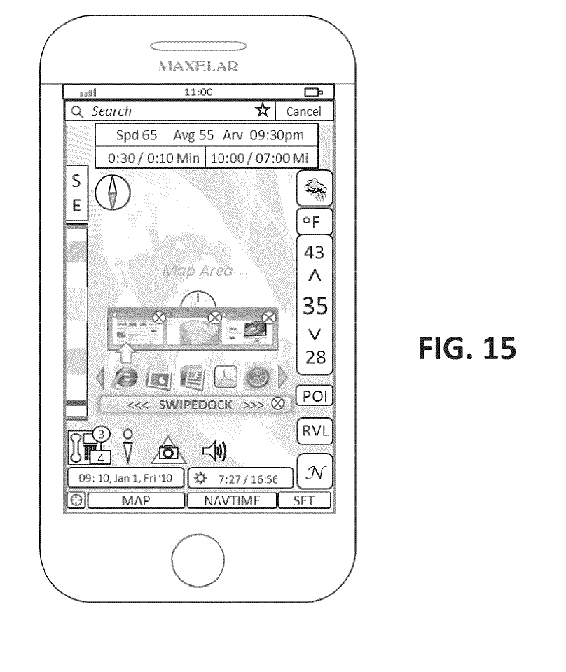

FIG. 16 is a view of progress bar;

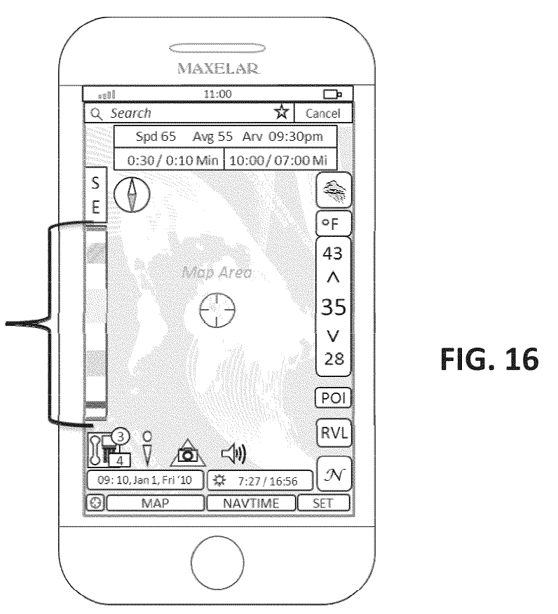

FIG. 17 is a view of route area;

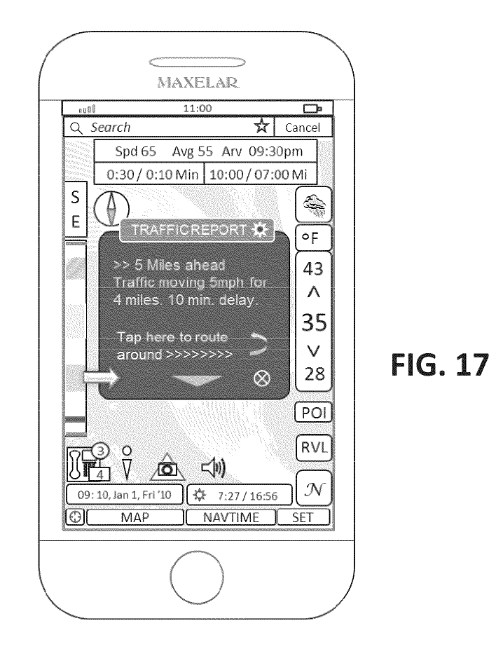

FIG. 18 is a view of incoming call;

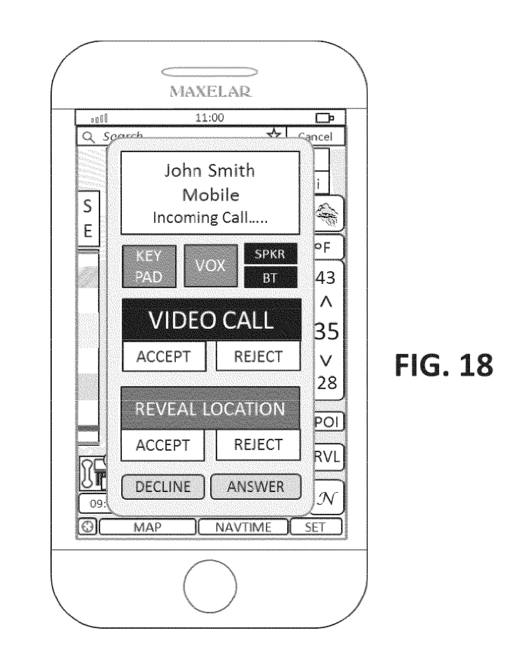

FIG. 19 is a view of video map;

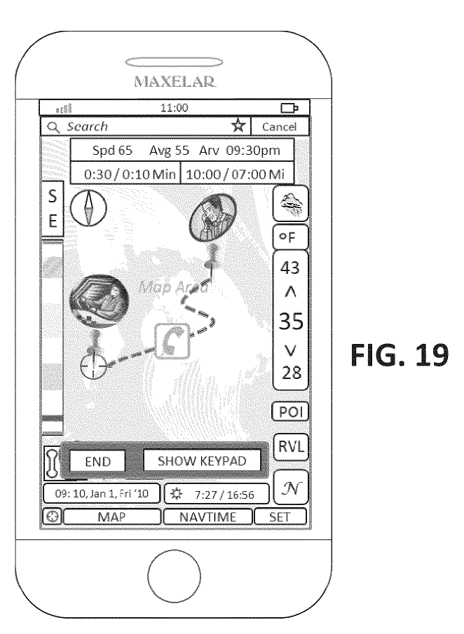

FIG. 20 is a view of reposition video windows;

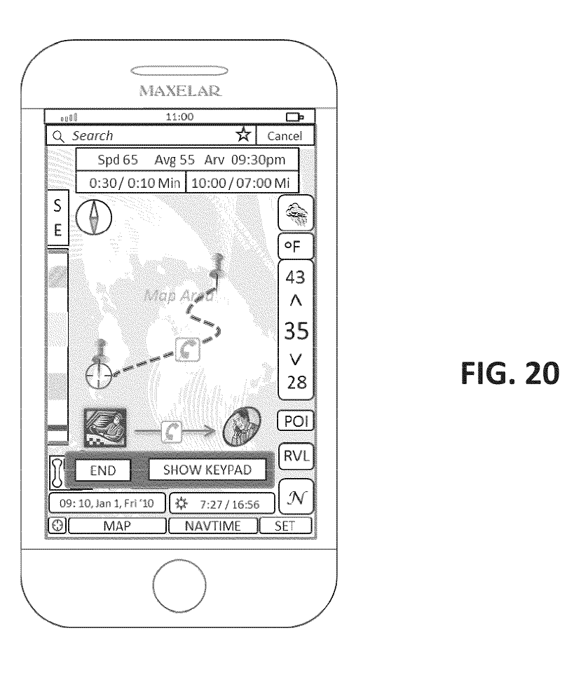

FIG. 21 is a view of live routing;

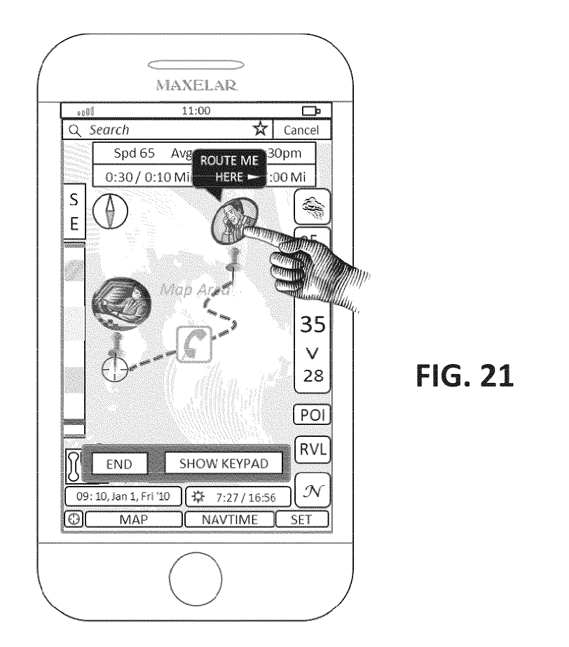

FIG. 22 is a view of dial pad disclose location;

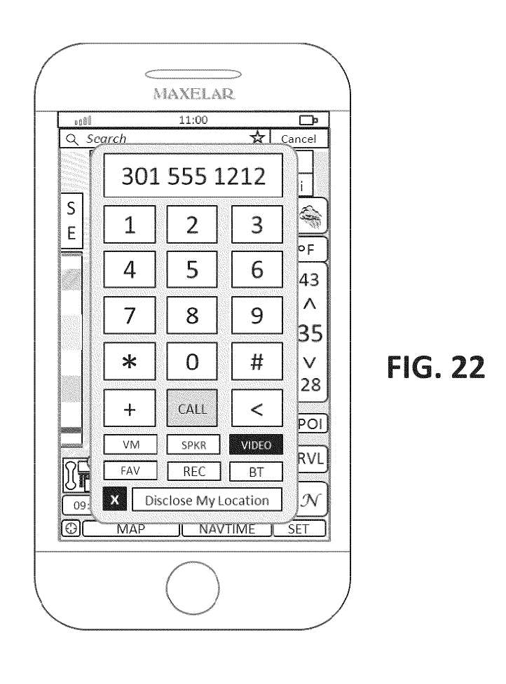

FIG. 23 is a view of video call mapping; and

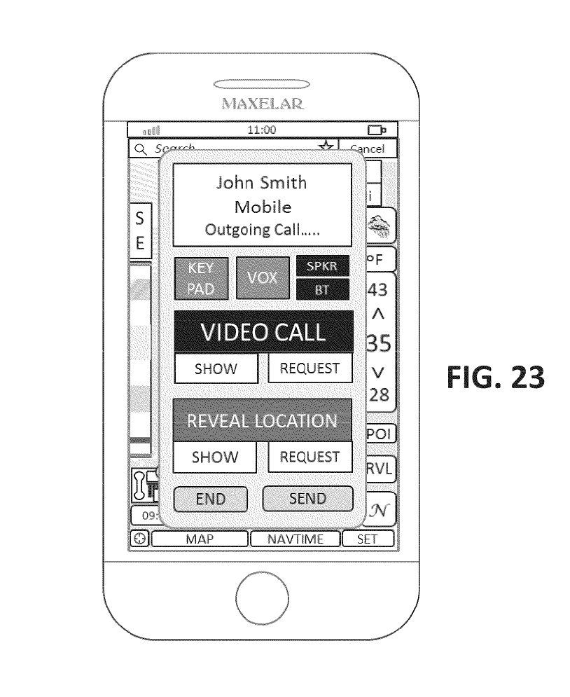

FIG. 24 is a view of hide all.

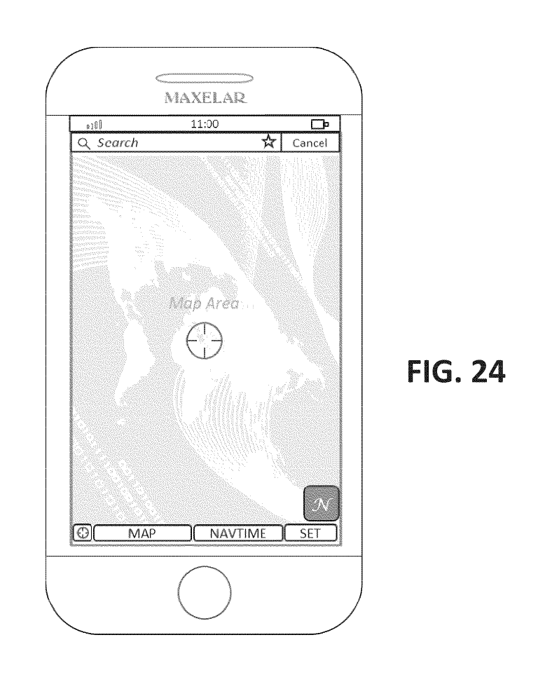

### DESCRIPTION OF THE PREFERRED EMBODIMENT

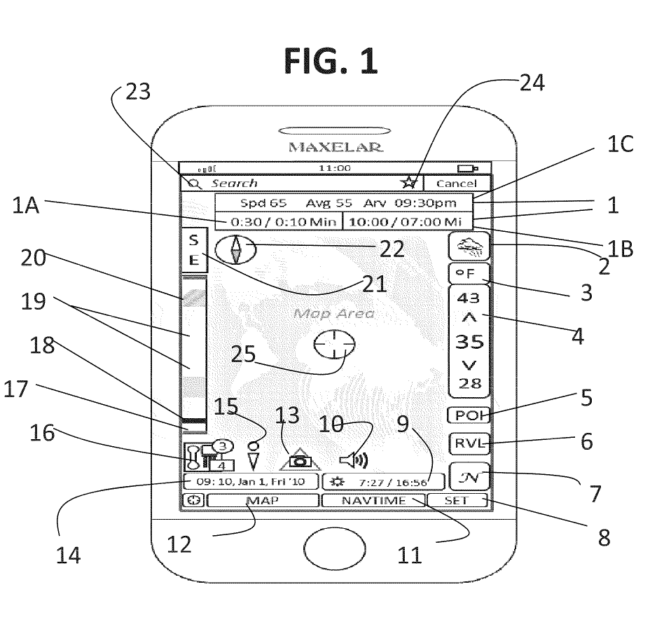

Referring to FIG. 1, there is disclosed a view of the front of the mobile device showing the various current or future navigation features displayed to an individual in accordance with the principles of the invention.

The area on the mobile device which is designated as the Stats Panel, 1, is like a Statistics information panel that is generally located at the very top of the navigation application screen and is generally rectangular in shape and is positioned right on top of an electronic or digital world map.

On one side in the panel there is a timer or stop watch 1A. The timer starts showing how much time is elapsing once a Navigation application is launched and the “locate me” feature is on. The “locate me” function is a known feature that enables real time tracking of a user and is shown by a designated tracking icon on the map. It is usually in a fixed spot located right in the center of the map but the map moves under the tracking icon to show progress of a moving person or object when it is on. The timer can be reset to zero when it is tapped once. The timer pauses or stops once the “locate me” feature is off and there is no live tracking enabled. When the locate me feature is on, the timer starts again from a zero position.

In the same Stats panel where the timer is located on the left side, a distance counter, 1B, is located on the right side. The distance counter shows how much distance is being covered in two different interchangeable formats automatically with the movement of a user after the application launch. Initially it shows in Miles but when tapped on it, it changes to the Kilometers mode of distance display instantly. It can be reset when it is double tapped.

The Stats panel also has another panel 1C that is located above or below the Timer and Distance counter. In this second panel is information that shows the current speed of movement, the average speed and also an Arrival time to destination if the Navigation application is in a “directions” mode.

On the upper right side of the map or the screen is the weather indicator area 2 that is initially represented by an empty frame that is shaped like a square with rounded corners. In this frame area, the weather is displayed with corresponding symbol icons that describe in picture form the current weather based on current user location automatically updated, or any location that is specified by a user in a search bar located above the map 25. With the movement of a user and with the locate me tracking function on and displaying on the map, the weather is continuously updated and the appropriate condition and symbol icon displayed on the map without further user intervention. Also, when a certain location is specified in the search bar, that place is searched and brought into view to the center of the map and a pushpin like icon drops on that area. Based on the place name and the pushpin drop, the most current weather information is retrieved from a computer weather server and automatically displayed in a picture form or icon in the weather frame area and also updated as it changes automatically. Also, whenever a user manually navigates the digital map with finger gestures by moving it or pinching or zooming on it and pauses for at least two seconds or more, a pushpin drops in the center 25 of the map and the weather and all info panels are updated automatically based on the location of the pushpin drop.

When the “Weather Indicator Icon” 2 is tapped once, another graphic object opens on its left or right side to show in text mode the same weather information that is displayed in picture mode by the weather indicator icons. If the weather text icon is tapped, or if the weather indicator icon is tapped, the Weather Text Description Icon closes but the Weather Indicator Icon still remains constantly visible.

When the Weather Text Description appears after the Weather Indicator Icon is tapped, below it also appears the Weather Forecast icon. When the Weather Forecast Icon is tapped, it opens a new window to show weather forecast up to 15 days.

Below the weather indicator icon is the Temperature panel 3. On the top side of the panel is a symbol icon that describes the current temperature data that appears below it, 4 in either Fahrenheit, Celsius or in a combination mode. Each successive time the Temperature panel is tapped, the temperature is automatically converted into the next designated format and the data displayed accordingly with the appropriate symbol icon showing.

Three types of temperature data are shown in the temperature panel 4. They include the maximum, minimum and current temperatures. The temperature data that is displayed in the panel is constantly and automatically updated from a server based on the current location of a user or a user specified location and is shown on the map. With the movement of a user and with the locate me tracking function on and displaying on the map, the temperature is continuously updated and the appropriate data displayed on the map in the temperature panel without further user intervention. This panel is positioned generally on the right side of the screen of the map. Initially, the temperature data is shown in Fahrenheit mode. When the panel is tapped once, it changes to a Celsius mode of data display. When tapped again, it shows in both Fahrenheit and Celsius modes. The style of data display is the following: The current temperature is positioned in the center of the panel in a slightly bigger font than the maximum and minimum temperature data. Above the current temperature data is an upward facing arrow to denote the high or maximum temperature for the day of a certain location and the maximum amount the temperature is forecast is shown above the upward facing arrow. Below the current temperature data is a downward facing arrow to denote the low or minimum temperature for the day of a certain location and the minimum amount the temperature is forecast is shown below the downward facing arrow. The up and down arrows are symbolic and are better suited than letters or words to denote the high and lows of a location's temperature and easily understood universally. Alternatively, the up and down arrows can be represented by letter symbols like “H” or “L” or anything similar, placed in a similar manner. Also, whenever a user manually navigates the digital map with finger gestures by moving it or pinching or zooming on it and pauses for at least two seconds or more, a pushpin drops in the center of the map and the temperature and all info panels are updated automatically based on the location of the pushpin drop. The form or design and function of the temperature display are unique to this Navigation application.

Area 5 is for user location based or specified points of interest (POI). There is a dedicated button located under the Temperature panel that can be used to customize the display of user selected Points of Interest on the map by double or long tapping on the button. When the menu opens, a user can select various Points of Interest from the categories available like Gas Stations, Hospitals, Grocery Stores, Parking places etc. The POI can be instantly switched off from showing on the map or switched on again by a single tap on the POI button.

The RVL button (Reveal button) 6 works in conjunction with the POI button 5 that is located above it on the right side of the map or screen. If the POI button is set to be on so that the various points of interest are shown on the map, the RVL button when tapped once shows all the POI details that are currently displayed within the map and screen area in a list format. This way, a user can easily find out more details of the POI that are displayed like addresses, phone numbers and so on of the displayed POI. The list that is displayed is only limited to the POI that can be displayed in the visible screen area.

There is an info panel that is an on/off dedicated button 7 located on the lower right side of the map or screen area which is generally symbolized by the logo of the application. This button when tapped once hides all the info-panels of the Navigation application. When tapped again, it shows all the info-panels. The purpose of this is that If a user only wants to see the map without being distracted by the info-panels, this dedicated button can help to turn on or off the info-panels.

When the SET button 8 is tapped; a user can set or choose among various options available for using the Navigation application.

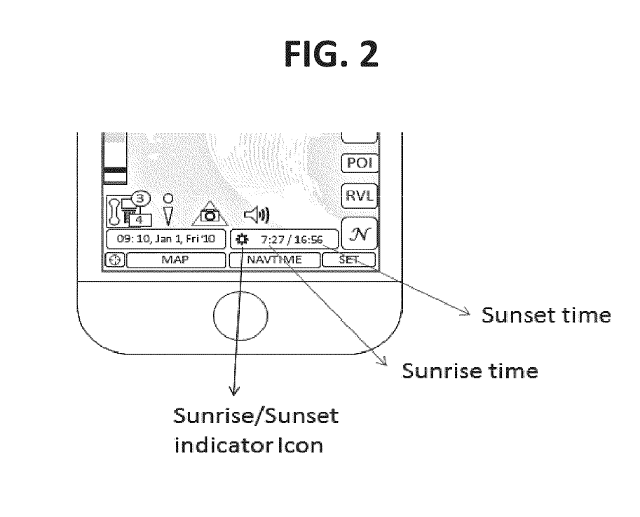

On the bottom right side there is a panel 9 that shows the Sunrise and Sunset information of a user's current or specified location, see FIG. 2. With the movement of a user and with the locate me tracking function on and displaying on the map, the Sunrise and Sunset information is continuously updated and the appropriate data displayed on the map in the Sun panel without further user intervention. Within the panel on the extreme left side is a Sun symbol or icon 9A and then the Sunrise information is positioned on its right side followed by a forward slash and then the Sunset information. E.g., 6:00/5:00 pm

There is a multi-source volume control that is located on the bottom middle side right on the map, area 10 for instant and easy access. Tapping on this icon will reveal a menu in which a user can easily and independently control music volume, voice guidance volume and overall volume instantly.

Tapping on the NAVTIME button 11 will switch to a directions mode.

Tapping on the MAP button 12 reveals a menu in which a user can select different available modes of viewing maps Satellite (aerial) mode or Hybrid mode etc.

Tapping on the traffic reporting button 13 will reveal a menu in which a user can choose to report traffic flow or report traffic accidents etc. This by itself is not unique. However, within this menu is also access to the camera function of any mobile device. This way, a user can instantly access the camera to take pictures of any accidents or other points of interest and save them to the favorites folder within the Navigation application itself.

The time and date panel 14 is located on the left bottom side upper row. This constantly displays the current date of a user's present location by default. If a user specifies any particular name in the search bar then it shows the local time and also the date of such location which is also displayed on the map simultaneously. When a user navigates the map by using finger gestures like pinching and zooming and then pauses for two seconds at least, a pushpin drops in the center of the map 25 and the time and date is updated based on such location. With the movement of a user and with the locate me tracking function on and displaying on the map, the time and date is continuously updated and the appropriate data displayed on the map in the Date panel without further user intervention.

The Contacts Alert button 15 is a dedicated button to enable social mapping, social navigation and associated alerts. When this icon is tapped once and is in the “ON” position, a user's contacts are displayed on the map as icons. A user can contact those contacts by tapping on each contact's icon and selecting a method by which to contact from a menu that opens when tapped. When this same Contacts Alerts icon is double tapped, all the contacts that appear on the map who have enabled self-location tracking will appear in a list form. A single tap will close the list form of display but will still continue to display the contacts as icons on the map. Another tap on the Contacts Alerts icon will hide all the contacts icons that appear on the map. The Navigation application will have a feature that will enable a user to create an account and add friends who may agree to be tracked and called from within the application. A user's contacts can also choose not to be tracked even when logged into the application. If the POI and Contacts are on at the same time, all will be simultaneously displayed on the map. When the RVL (Reveal button) is tapped both categories will be displayed separately in different rows for easier differentiation.

The Navigation application has an icon that resembles a telephone in area 16 that is generally located on the extreme left side of the screen. This has three functions. It can indicate the arrival of email in the form of a small square box that appears on the lower right side of the telephone icon. Within the box is also shown the number of emails that are pending a review. On the upper right side of the telephone icon, a circle appears in which is shown the number of voicemail messages if such have been received. If a user taps once on the telephone icon, a window opens to show emails received and also any voicemails that have been received without the user having to leave the navigation application. A user can also access the full functionalities of email and phone communication within the same menu or window. A person can conduct real time telephone calls without leaving the navigation application by tapping on the appropriate place in the menu window that opens a dial or keypad when the telephone icon is tapped once. The same applies to the email function. A user can compose or reply to email messages without leaving the navigation application.

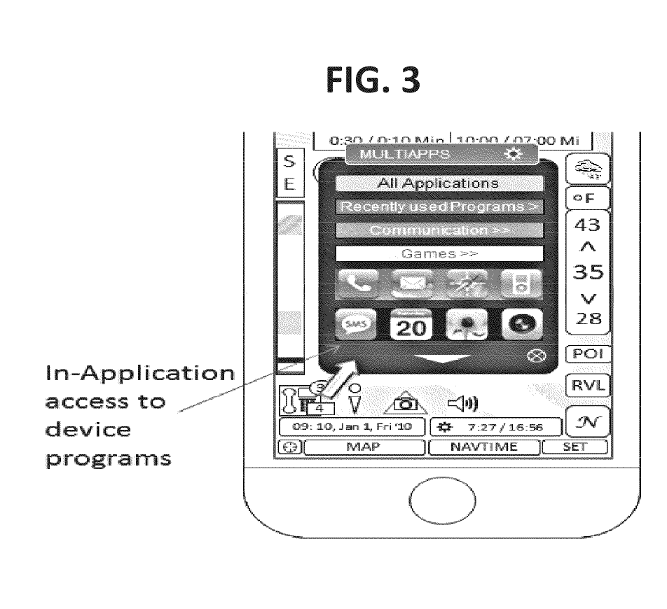

While in the InApp program, the same menu that opens when the Combo Communication button opens, there is a link or buttons to see and open other applications that maybe currently installed on the mobile device without the need to leave the navigation application, see FIG. 3. Many useful features like “Recently used Programs” and all programs listed by category are implemented. The program behind this feature automatically organizes all the programs installed on a mobile device into easily viewable categories which are easily scrolled for further selection. All the programs open within the Navigation Application itself. Thus, the Combo-Com icon functions as a link and a virtual parallel interface between the Navigation Application and all other programs or applications that are installed on the mobile device facilitating the use of those programs within the Navigation Application itself and the ability to view and swipe between those applications on a virtual type taskbar.

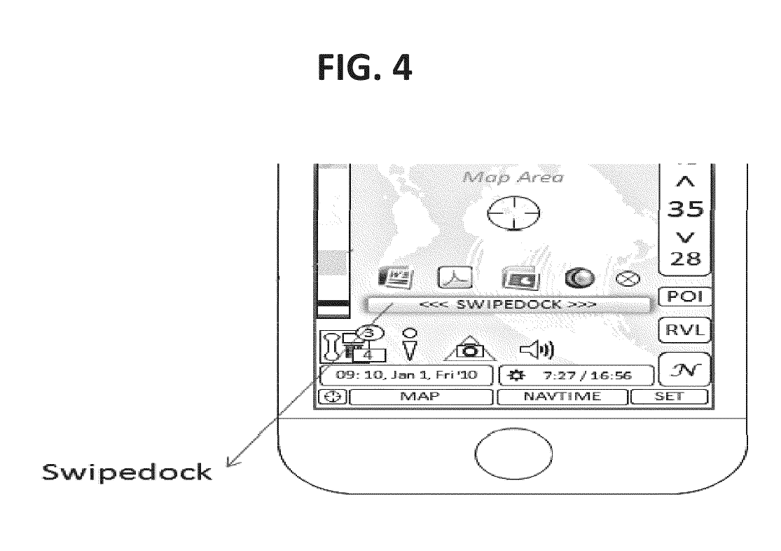

When the Navigation application is tapped once anywhere, an interactive semitransparent bar appears in the lower half of the screen (see FIG. 4). Swiping on this bar brings the open applications running or available on a mobile device into view over the bar in the form of the applications' corresponding icons. A user can then choose to open any of the applications within the Navigation application itself. Any applications that have been opened within the Navigation application will be continuously present as mini icons positioned over the Swipe Dock. This way, a user can swap between various opened applications on top of the Navigation Application by swiping between them. A user can choose to close any of the open applications as needed by tapping on an application icon's close button. The virtual taskbar automatically disappears if there are no multiple applications running within the Navigation Application or by re-tapping on the swipe dock to hide it. In prior art the taskbar or the application dock usually appears permanently at the bottom or any side or it has an “auto-hide” feature. But in this Navigation Application, the taskbar referred to here as the “Swipe Dock” only appears when the Navigation application is tapped once, see FIG. 4.

The “STATUS PANEL” or Progress bar 17 is generally located to the extreme left middle side of the screen in the navigation application. The progress bar has two functions. The first is to show a user's progress from a start point to an end point when in a “directions” mode. A user's progress is shown in the form of a visible colored meter that moves up the progress bar as a user moves from point A to point B. This helps to give a visual idea of how much a route was covered and how much is left to be covered in the form of a bar. In a non-directions mode, the meter does not move. The second function is to show traffic conditions ahead of the same road a user maybe on whether in a directions mode or not, at any given time, up to 20 miles ahead if the road is that long or whatever length the road may be if less than 20 miles long. In the progress bar the traffic conditions may be reflected in the form of colored boxes or areas that appear embedded in the progress bar at various distances which is calculated in a straight line ahead from the point of user's location. Different colors may reflect a certain traffic condition ranging from very slow to regular. Red or black can indicate very slow and yellow can represent slow. For example, if there is a traffic slowdown five miles ahead of the same road a user is on and if that traffic condition is there for about two miles in length then a colored box appears to correspond with such situation to give an instant visual indication of such. If a user then taps on the colored boxes/areas that may appear in the progress bar, traffic details are displayed in a separate window that opens beside the progress bar on the right for example. A user then can have options to get directed around a certain traffic obstruction from within this display window. This feature is normally available in a routed scenario as seen in other existing GPS systems or if a user is almost close to a traffic condition in a non-routed scenario. But in this navigation application, the ability to get traffic conditions and the ability to get routed around any obstruction in a straight line “on the same road” type of method is possible whether in a routed mode or not up to 20 miles in advance from the point a user is located. If traffic alerts service is not available, then lightly colored cross lines are shown in the progress bar to indicate that there is no traffic service available for that area of the road the user maybe travelling on.

The progress meter, area 18, is located inside the Progress bar which shows the progress of a user within a routed scenario from one point to another in “directions” mode. In a non-direction mode, the meter does not move.

The traffic status indicator boxes 19 that appear in the progress bar are colored to show various types of severity of traffic alerts to correspond with the length of the traffic situation in yards, miles or kilometers.

When any traffic indicator box is tapped once, a pop out window 20 opens to show more details about the corresponding area. A user can choose to be routed instantly around any traffic obstruction from within that pop out window. This feature is available in a routed and a non-routed mode as well. Traffic information service if available is shown in the Status panel in a routed and non-routed mode as well. Traffic information can be shown up to 20 miles ahead in a straight line on the road a user maybe traveling.

Above the progress bar on the left side is located the text compass panel 21. This reflects the direction a user may be heading or pointing a mobile device toward like North, South, West, Northwest, etc. This method of placing this style of text box right on the map itself and the display style is unique in that the directions are shown in vertical mode to fit in a smaller space.

On the right side of the Text compass panel is located a generic compass icon 22. This style of placement next to the Text Compass Panel and on the map itself is unique to this application. The white side of the compass arrow points to the North and the gray side of the compass arrow points to the South. This does not show which direction the user is moving but only which side is north and which side is south relative to the user's moving direction.

There is a search bar 23 at the top of the Navigation application.

There's a bookmark icon 24 on the right side inside the search bar. Tapping on that shows bookmarked places.

When a telephone calling feature is activated from within the Navigation application itself via the Combo-Com function or even outside the application on the hosting mobile device as a standalone feature, the call menu screen or keypad shows an option to reveal the current location and the video of the call initiator temporarily. To prevent unwanted map and video revelations, the default setting is always in the OFF position. To activate the Video Call Mapping feature during a phone call, the call initiator and also a call recipient must tap on an appropriate check box to activate the features as maybe mutually desired and agreed upon. When this happens, one or both parties as they may have chosen can view each other's real time location and video on a map that becomes visible in addition to the keypad that becomes smaller and a digital map shows above it. Once the call is terminated, the Video Call Mapping setting goes back to the OFF position.

An incoming menu for Video Call mapping has options for a recipient to choose from or reject. After first choosing various options to engage in video and or mapping, a final button called ANSWER needs to be tapped to accept the incoming call.

After making an outgoing call that may not have included video and mapping requests, the call initiator has options to still make video and mapping requests during an outgoing call as shown in the outgoing call menu here.

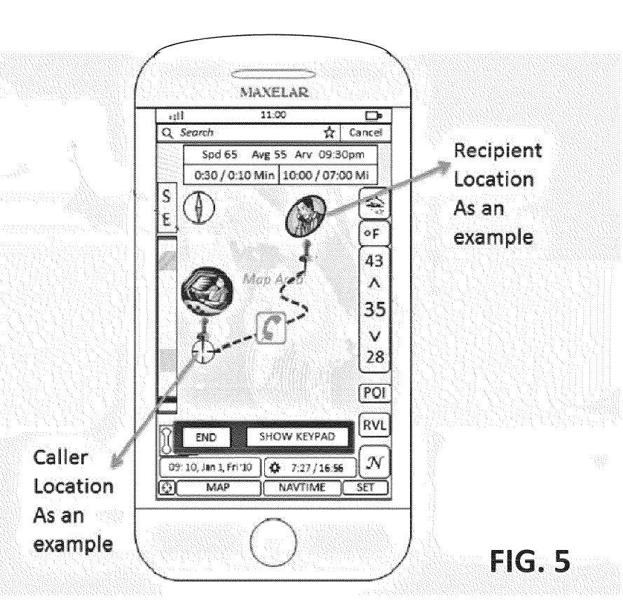

Once a video call mapping has been established, two or more parties can see each other in video and their respective locations on the map indicated by pushpin drops. Pushpins drop in the respective places on the map to indicate where each person is located. If the pushpin of the caller is tapped once, the info-panels display the overall weather conditions of the caller's location. If the pushpin of the recipient is tapped once, the overall weather conditions of the recipient will populate the info panels. Another feature is that tapping around each pushpin will progressively show the map area around the respective parties more and more (selective zooming in) but all parties of a video call mapping will always be within view of each other during the Video Call mapping on a digital map, see FIG. 5.

In the duration of a call that may have video and mapping features enabled, individual features can be turned off by accessing the Call duration menu.

Once a call has been established, any party can click or tap on another feature called the “ROUTE ME HERE” button that pops up when the designated pushpin or video of each plotted contact is tapped on. Once the ROUTE ME HERE is selected, a request message is sent to the other party to accept or deny the request. If the request is accepted, each contact can be directed to the other in real-time even as both maybe moving and talking at the same time. The live routing to each party will continue until one or both parties reaches the desired destination or with a manual routing termination at any time.

Another method to view all the info-panels of the Navigation application in a very small space is by the Navtime toolbar feature. The toolbar is a thin rectangular strip like bar that is activated when the very top bar or area of a mobile device is double tapped for example. When this happens, the Navigation toolbar is revealed in which all the weather information is shown in a minimized manner in a thin rectangular strip. Within the toolbar is a link to the larger Navigation application that can be launched by a tap on it. Tapping on this link will also launch the digital map on a mobile device as well. The Navigation toolbar can be launched across any application on a mobile device for example. It can be hidden again by double tapping on it.

This navigation application also has other uses such as Television applications besides the one illustrated for mobile platforms. The application for Television based platforms is like this:

Usually, a user can check the latest weather or such by going to a dedicated weather channel or trying to load an interactive application from a TV menu or waiting for a weather forecast to be given on a certain channel at some regular intervals. In this manner it is not easy to get weather instantly as and when a person may want to on a Television type system.

The Navigation application can be installed or integrated in a Television or a connected set top box so that once a user simply taps on a general “select” or any button that is so programmed once or twice on a corresponding Television remote control, then a rectangular strip like bar or weather bar is shown on the very top or bottom of a TV screen and shows the most needed weather data for the current location of a user. Once the weather bar shows, more details about local or any other specified region's weather and traffic and such can be navigated by using the TV remote control's left, right and other jog options.

When a user presses on the “Enter” or any dedicated button on the TV remote another time after the weather bar has already been launched, the current channel that is being watched can reduce in size to about 90% so that the sides of the screen can show the Navigation application with weather, temperature, map with traffic etc. without hiding any portion of the channel that is being watched. Another empty “enter” stroke action can further reduce the TV channel that is currently being watched to about half the full size and then a user can see more interactive and instant information related to traffic, weather, weather forecast, current temperature, related location based news and such on the other half of the TV screen while also watching a regular TV channel on the other half side of a TV channel. Another tap can fully show the Navigation application with an interactive digital world map and weather forecast fully on a TV screen. Another empty tap after the weather application has fully launched will close the application.

In a typical desktop manual map navigation scenario on the Internet, there is no automatic display of any weather or related navigation information as described here. But, with the implementation of the algorithms and parameters that are required to display automated navigation information on digital maps as found on the internet, then all weather and traffic related info can be automatically displayed based on where a user navigates to.

The desktop application has a similar function that can show all the navigation related info as on a mobile device. But additionally, a user will be able to monitor multiple regions' weather and related information in one strip view that may be located on the side of a desktop monitor. When a person clicks on any region that is being monitored, then a bigger window opens on the side of the application to show the same region's multiple day forecast, its traffic information and so on. In the same window, a user can also see all other regions' weather, forecast and traffic related info that has been previously customized as well and be able to scroll through all the regions selected for viewing or monitoring.

Using a dedicated button or key stroke action to launch the Navigation application: this approach can be taken on a mobile device so that when a certain dedicated button is clicked once or twice, then the navigation application instantly launches showing all weather and travel related information without the need for a user to search for the navigation application within the mobile device to launch such navigation application.

Google Maps on the iPhone does not offer landscape view for its maps. But a special programming method has been used to make that a possibility for the Navigation application to work on top of Google Maps in landscape mode.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are entitled.

What is claimed is:

1. A mobile navigation device for route guidance combined with information related to the route guidance and with a digital map display updated to show travel and complete weather related types of information in an easy to understand user interface that better aids a user in knowing travel conditions in the context of real time GPS aided navigation on a mobile device or desktop finger navigation of digital maps or on a Television platform wherein the navigation device comprises a navigation application icon which when activated includes weather, temperature, time and date and sunrise and sunset indicator icons or panels which, upon simultaneous activation displays full weather details with corresponding symbol icons that describes in picture form the current weather based on current user location automatically updated, or any location that is specified by a user in a search bar located outside the digital map display on the digital map itself.

2. The mobile navigation device of claim 1 wherein, the Temperature display style is displayed in a vertical rectangular bar located on the farthest side of a screen where the current temperature is displayed in the center of the bar with a larger size font; the maximum temperature for the day is positioned above it in a smaller font separated by an upward facing arrow like symbol and the minimum temperature for the day is positioned below the current temperature separated by a downward facing arrow like symbol; wherein an upward facing arrow denotes the maximum temperature and a downward facing arrow denotes the minimum temperature for the day; wherein the very top of the Temperature bar is an icon which denotes the format of the displayed temperature in Fahrenheit or Celsius modes and tapping on the Temperature bar successively changes from Fahrenheit to Celsius or combination display modes.

3. The mobile navigation device of claim 1 wherein, when a certain location is specified in the search bar, that place is searched and brought into view to the center of the map and a push pin like icon drops on that area, and based on the place name and the push pin drop the most current weather information is retrieved from a computer weather server and automatically is displayed in a picture form or icon in the weather frame area and updated as it changes automatically; and wherein weather information includes temperature, sunrise, sunset, time or date or related information displayed in all the corresponding information panels in the Navigation application.

4. The mobile navigation device of claim 3 wherein when a user navigates the digital map with finger gestures by moving it or pinching or zooming on it and pauses for at east two seconds or more, a push pin drops in the center of the map and the weather and all info panels are updated automatically and continuously when any changes happen based on the location of the push pin drop; and wherein weather information includes temperature, sunrise, sunset, time, date or related information displayed in all the corresponding information panels in the Navigation application.

5. The mobile navigation device of claim 3 wherein when the weather indicator icon is tapped once, another graphic object opens to show in text mode the same weather information that is displayed in picture mode by the weather indicator icon.

6. The mobile navigation device of claim 5 wherein when the weather indicator icon is tapped twice or tapping on a dedicated forecast icon or area that is revealed that is located under another graphic text description object that is revealed when the main weather indicator icon is tapped then it opens a new window that shows weather forecast up to fifteen days.

7. The mobile navigation device of claim 1 wherein sunrise/sunset information of a user's current or specified location is shown directly on a digital map or with the movement of a user the sunrise/sunset information is continuously updated based on current location always and the data displayed without further intervention by the user.

8. The mobile navigation device of claim 1 wherein tapping on a traffic reporting area will reveal a menu in which a user can choose to report traffic flow or report a traffic accident or provide access to a camera function to provide the user instant access to a camera to take a picture of an accident or other points of interest and save the picture to a favorite folder within the navigation application itself.

9. The mobile navigation device of claim 1 wherein the navigation application has an icon that resembles a telephone that has the functions of indicating the arrival of emails, the number of emails that are pending a review, the number of voice mails received without the user having to leave the navigation application.

10. The mobile navigation device of claim 9 wherein the user, without leaving the navigation application can access the full functionalities of email and phone communication and conduct real time telephone calls.

11. The mobile navigation device of claim 1 wherein, without leaving the navigation application there is an icon that allows the user to see and open other applications that are currently installed on the mobile device which include recently used programs or all programs listed by category installed on the mobile device.

12. The mobile navigation device of claim 1 wherein by tapping once on the navigation application icon causes an interactive semitransparent bar to appear which, when swiped brings the open applications running or available on the mobile device into view and available to be opened by the user.

13. The mobile navigation device of claim 12 wherein the interactive semitransparent bar only appears when the navigation application is tapped once or similarly by the activation of some dedicated shortcut.

14. The mobile navigation device of claim 12 wherein a user can choose to close any of the open application by tapping on an application icon's close button.

15. The mobile navigation device of claim 8 wherein there is multi-function progress bar that shows traffic indications by various colored boxes along the road a user maybe traveling up to twenty miles ahead and whether or not in a directions or routed mode and also show the progression of a user in a directions or routed mode in the form of a moving plotting bar or meter from a starting point to a destination point.

16. The mobile navigation device of claim 1 wherein the ability to get traffic conditions by tapping on a traffic alert boxes that may appear on a progress bar and the ability to get routed around any obstruction in a straight line on the same road is available whether in a routed mode on not up to twenty miles in advance from the point a user is located.

17. The mobile navigation device of claim 16 wherein when traffic alerts service is not available lightly colored cross lines are shown to indicate that there is no traffic service available for that area of the road the user is traveling on.

18. The mobile navigation device of claim 16 wherein a text compass that is located next to a generic compass icon that shows the direction that a user is heading or pointing the mobile device toward and wherein a vertical triangle style box and a vertical text placement style in the box is a space saving design.

19. The mobile navigation device of claim 1 wherein the navigation application includes an incoming menu for video call mapping which includes options of speakerphone or Bluetooth for the user to choose or reject.

20. The mobile navigation device of claim 19 wherein after video mapping is established two or more parties can see each other in video and their respective locations on a map indicated by pushpin drops.

21. The mobile navigation device of claim 20 wherein when the callers pushpin is tapped once the overall weather conditions of the recipient will be shown.

22. The mobile navigation device of claim 21 wherein all parties of a video call are always within view of each other on a digital map and wherein the video windows also can be repositioned so that both windows are on the same horizontal level on the bottom side of the digital map and wherein the dual pushpins show where each party is located on the map.

23. The mobile navigation device of claim 22 wherein selective map zooming in or out can take place by tapping around the pushpin or the video image of any party but with both parties still in view of each other on a digital map.

24. The mobile navigation device of claim 23 wherein live routing to each party's current location can take place before or after a telephone call has been placed and even when both parties are in motion and the ability to terminate such live tracking and video conferencing displayed simultaneously on a digital map wherein the button or options to activate live routing and disclosing any person's current location is conveniently located on the dial pad itself and wherein these same options can be available on standalone telephone calling applications that have dial pads to input desired selections.

25. The mobile navigation device of claim 24 wherein a timer panel generally located on the top left side on the digital map is placed wherein the timer panel is a stop watch that begins when the navigation application is launched with location tracking on wherein the amount of time that is elapsing is shown automatically and can be reset by a double tap on the timer panel;
and wherein, when the location tracking is off, the stop watch pauses and resumes when the location tracking is activated again.

26. The mobile navigation device of claim 25 wherein a distance counter panel generally located on the top right side on the digital map is placed in the panel wherein a distance counter shows how much distance is covered in miles first once a user starts moving and wherein tapping on the counter changes to a kilometers mode of display simultaneously converting any data that is in the miles mode and wherein double tapping on this counter resets the counter to zero.

27. The mobile navigation device of claim 26 wherein the entire navigation application's select core features like all weather related information without a digital map can be displayed as a toolbar that can be activated by single or double tapping on the very top side of a mobile or navigation device. wherein any single button of a mobile device can be programmed as such to display the navigation toolbar; wherein a toolbar on the top side is a thin rectangular bar that only shows the most needed weather and compass information without the digital map in a compact manner; wherein the digital map can be launched by tapping on a dedicated map icon within the toolbar; wherein. tapping again on the toolbar hides it and no matter which other program or application may be active, the Navigation toolbar can always be activated simultaneously and constantly viewed no matter which other application maybe be in active use on a mobile device.

28. The mobile navigation device of claim 27 wherein the entire Navigation application's select core features like all weather related information without a digital map can be displayed as a Television toolbar that can be activated by single or double click on TV's remote control wherein when the toolbar is activated it appears as a weather bar on the top side or any side on the TV screen which can be an integrated bar that can show both a currently viewed channel information and also the current weather information of the current area a user may be located in wherein successive taps on a dedicated button or any “Enter” or “Select” button can progressively display more weather information on one side of the TV screen by simultaneously reducing a currently viewed channel size and also display a digital map on which live traffic information can be seen among other travel related information.

29. The mobile navigation device of claim 28 wherein a similar display of weather related information in the various information panels or as toolbar with continuous and automatic updated information displayed can be adapted to desktop digital maps retrieved or viewed via the Internet.

30. The mobile navigation device of claim 29 wherein there is a dedicated “Reveal” button to reveal all the Points of Interest or POI that maybe displayed on a digital map in a list to select and view more details of any point of interest currently displayed on the digital map.

31. The mobile navigation device of claim 30 wherein a single button can hide all the info panels by a single tap and revealed again with a single tap.
